(19) United States
(12) Patent Application Publication
(10) Pub. No.: US 2008/0306201 A1
(43) Pub. Date: Dec. 11, 2008

(54) Acrylic Compositions Comprising Nanoparticulate Zinc Oxide Uv Absorber

(76) Inventors: Reno Emilio Beltrame, Victoria (AU); Michael Ary Bos, Victoria (AU)

Correspondence Address: NIXON PEABODY LLP - PATENT GROUP, 1100 CLINTON SQUARE, ROCHESTER, NY, 14604, US

(21) Appl. No.: 10/583,615

(22) PCT Filed: Dec. 22, 2004
(86) PCT No.: PCT/AU2004/001807

§ 371 Date: Dec. 6, 2006

(30) Foreign Application Priority Data
Dec. 24, 2003 (AU) 2003907188

(51) Int. Cl. C08K 3/22

(52) U.S. Cl. 524/432

(57) ABSTRACT

The invention relates to an acrylic composition comprising an acrylic component selected from acrylic resins and precursors thereof and a nonoparticulate zinc oxide UV absorber wherein the acidity of the acrylic composition is less than 0.5 g KOH per kilogram of resin solids.

The present invention relates to UV stabilized acrylic compositions and in particular to acrylic based systems containing a nano zinc oxide UV stabilizer and to a method of preparing UV stabilized acrylic coatings.

### BACKGROUND

Aqueous acrylic emulsions and solvent-based acrylics have been used for paints, timber vanishes, adhesives and textile coatings since the early 1950's. These acrylics are usually formulated with acrylic acid, methacrylic acid, itaconic acid or other acid groups to provide special features such as shear stability, adhesion, cross-linking, water resistance, required Tg, hardness, mar-resistance, mechanical stability and other desired properties.

Examples of typical acrylic emulsion are discussed in patents and product literature some of which will now be discussed. In what follows the discussion of documents, acts, materials, devices, articles and the like is included in this specification solely for the purpose of providing a context for the present invention. It is not suggested that any or all of these matters formed part of the prior art base or were common general knowledge in the field relevant to the present invention before the priority date of each claim of this application.

Uenoyama Yasuyuki in Japan (Asahi Chemical Industry Co., Ltd., Japan). Jpn. Kokai Tokkyo Koho JP 10120724 A2 12 May 1998 Heisei, JP 96-274874 17 Oct. 1996 describes the method of preparation of acrylic emulsion by emulsion polymerization of radically polymerizable monomers in aqueous media in the presence of UV absorbers and/or light stabilizers, such as Tinuvin 384, and modifying with silicones during or after the polymerization. The emulsions are suitable for adhesives, paper treatment and finishes for fabrics. An enamel coating was glossy and is said to be weather and water-resistant.

Lorah et al in USA, patent US 2001-981350 17 Oct. 2001 describes a method for preparing an acrylic composition which is said to be suitable for use, when dry, as an improved elastomeric coating, caulk, sealant, fabric treatment or pressure sensitive adhesive. The composition is provided, including a predominantly acrylic aqueous emulsion polymer, the polymer having a glass transition temperature Tg from (−) 90 to 20 C, formed by the free radical polymerization of an ethylenically unsaturated nonionic acrylic monomer and 0-7.5%, (by wt. based on the total weight of the polymer), ethylenically unsaturated acid monomer in the presence of 0.01-1.0% tert-alkyl hydroperoxide, tert-alkyl peroxide, or tert-alkyl perester, wherein the tert-alkyl group includes 5 C atoms and, optionally, another oxidant.

Examples of industrial water based acrylic emulsions include:

Rohm & Haas: “Primal” range of water-based acrylic emulsions:

Primal AC 6501 M; Primal MV 23L0; Primal RHA 184; Primal RHA 194;

BASF: “Acronal” range of water-based acrylic emulsions:

Acronal 290 D; Acronal 250 D; Acronal 32 D; and

Valchem: “Valbond” range of water-based acrylic emulsions:

Valbond HBS 2; Valbond HBS 4; Valbond 7275; Valbond 82-48S.

There are some examples of lower acid water based acrylic resins, which have been made specifically for adhesives, such as

Rhodia: “Rhodatak” range of pressure-sensitive water based emulsion adhesives. These acrylic adhesive emulsions are not suitable for non tacky surface coatings.

Clear coatings made with water based acrylic emulsions or solvent based acrylics have major draw backs. Ultraviolet light produces relatively rapid deterioration in the film and in many cases also in the substrate coated by the film. In order to protect the coating film and the substrate from UV degradation, a range of organic UV absorbers and HALS (Hindered Amine Light Stabilizers) have been used. Organic UV absorbers mostly absorb in the range of 190-320 nm and do not give protection in the 320 to 400 nm UVA—band. HALS are free radical traps, may be used alone, but are often used in conjunction with organic UV absorbers in clear films. These products provide limited UV protection and will deactivate over time resulting in degradation of the film and substrate.

The use of physical UV—blockers such as zinc oxide of pigmentary grade (150-200 nm mean particle size) give protection in the region of 190-400 nm and in the visible band. They have been used effectively in UV absorbing acrylic composites. When zinc oxide of 150-200 nm particle size is mixed into an aqueous acrylic emulsion containing free acid groups, the outer part of the particle reacts with the acid to produce a zinc-polyacrylate coating, which protects the zinc oxide core residue from further reaction.

However the use of pigmentary grade zinc oxide of 150-200 nm and larger than 200 nm in aqueous acrylic emulsions (typical levels of 7%) is limited, because it produces milky or opaque films and leads to stability problems causing unwanted viscosity increases and altered rheology with poor can stability, gelling or “livering”.

### SUMMARY

In an attempt to improve the stability of clear films and acrylic compositions we conducted experiments using nano size zinc oxide. However we found that the use of nano size zinc oxide with commercial acrylic emulsions does not provide effective UV protection.

We have now found that by using acrylic compositions (or monomers for preparation thereof) with exceedingly low acidity (<0.5 g KOH/Kg of resin solids) we can use nano size zinc oxide dispersions (with particle size 10-100 nm, preferably 10-50 nm) to give a stable dispersion of zinc oxide for use in a range of coating applications.

Accordingly we provide in a first aspect of the invention an acrylic composition comprising an acrylic component selected from acrylic resins and precursors thereof and a nonoparticulate zinc oxide UV absorber wherein the acidity of the acrylic composition is less than 0.5 g KOH per kilogram of resin solids.

In a second aspect the invention provides a method of manufacture of a zinc oxide stabilized acrylic composition comprising forming an acrylic composition having an acidity of less than 0.5 g KOH per kilogram of resin solids and dispersing therein a nanoparticulate zinc oxide composition. The acrylic composition may be selected from acrylic resins and acrylic resin precursors such as the monomer compositions from which the acrylic resin is derived. In a third aspect the invention provides a zinc oxide composition comprising nanoparticulate zinc oxide comprising a surface coated with an acrylic monomer.

In a fourth aspect the invention provides a method of forming a zinc oxide stabilizing agent for an acrylic composition comprising:
contacting the zinc oxide nanoparticles with an acrylic monomer to form a coating of the monomer on the zinc nanoparticulates;
polymerizing a monomer composition comprising acrylic monomer in the presence of the acrylic monomer coated zinc oxide nanoparticles to provide zinc oxide encapsulated in acrylic resin.

In a fifth aspect the invention provides a coating composition comprising the above-described acrylic composition comprising the nanoparticulate zinc oxide and optionally other additives such as surfactants, defoamers, chain transfer agents, plasticisers initiators and stabilisers.

The coatings of the invention are particularly suitable for textiles. We have found that the composition provides significantly improved resistance to weathering and in many cases also enhances colour.

Accordingly in a sixth aspect the invention provides the use of the aforementioned composition as a textile coating and a textile coated therewith.

### DETAILED DESCRIPTION

The invention relates to acrylic resin compositions and in particular to acrylic film forming resins and coating compositions.

The composition of the invention comprises nanoparticulate zinc oxide and an acrylic composition selected from the group consisting of acrylic resins and precursors, such as monomer compositions, for preparation thereof. Without wishing to be bound by theory we believe the poor performance of nano zinc oxide in commercial emulsions results from the acid containing (above 0.5 g KOH/Kg of resin solids) acrylic emulsions dissolving the fine zinc oxide particles and/or from some of the zinc ions forming complexes with the polyacrylate. For example we found that when a commercially available emulsion such as Rohm & Haas (Primal AC 6501 M), which is typical of current commercial emulsions is mixed with 2% nano size zinc oxide (35 nm) and cast as a 50 μm film, UV absorption test showed that zinc oxide had dissolved and it provided no UV protection.

The term acrylic is used herein in a general sense to mean resins or monomer compositions for preparation thereof where a significant fraction of the monomeric units or monomers are selected from the group consisting of acrylic and methacrylic esters. It will be understood that co-monomers such as styrene, vinyl acetate, acrylonitrile, acrylamide, n-methylol acrylamide, vinyl acetate and others may be included. In what follows we describe a number of resin compositions but it will be appreciated that the corresponding monomer composition may also be used in admixture with the nanoparticulate zinc as a precursor to such a composition.

Copolymers and mixtures of monomers will preferably contain at least 10 mole percent of the total of acrylate plus methacrylate monomers based on the total mole of monomers. More preferably the proportion of acrylate plus methacrylate monomers is at least 20 mole percent and most preferably at least 40 mole percent.

The acrylic resin may be present in a range of forms. In one embodiment the acrylic resin is a high molecular weight thermoplastic acrylic such as acrylic resins of the type widely used as a coating for new automobiles and to a limited extent in repair and refinish of automobiles. The acrylic resin may be a thermo setting acrylic resin or non-aqueous dispersion (NAD) acrylic which is a thermosetting solution. Alternatively the acrylic may be in the form of acrylic latices which may commonly include styrene or vinyl acetate acrylic copolymer latices which are used in place of drying oils and alkyd systems.

In one embodiment the acrylic resin comprises hydroxy-functional thermosetting acrylics of the type widely used in baking enamels for automobile and appliance top coats, exterior can coatings and coil coatings.

Specific examples of acrylic resins are copolymers of acrylate and/or methacrylate esters of organic alcohols and other unsaturated monomers (that is having at least one double or triple bond) capable of reacting by additional polymerisation in aqueous media. The acrylate and methacrylate ester monomers may have alcohol portions selected from alkyl, hydroxyalkyl, alkoxyalkyl, alkylaminoalkyl and dialkylaminoalkyl. Such monomers are readily available. Specific commercially available examples include methyl (meth)acrylate, ethyl (meth)acrylate, n-butyl (meth)acrylate, isobutyl (meth)acrylate, isodecyl (meth)acrylate, lauryl (meth)acrylate, stearyl (meth)acrylate, 2-hydroxyethyl (meth)acrylate, 2-hydroxypropyl (meth)acrylate, 2-dimethylaminoethyl (meth)acrylate, 2-t-butylaminoethyl (meth)acrylate, glycidyl (meth)acrylate, ethylene glycol di(meth)acrylate, 1,3-butylene di(meth)acrylate and trimethylolpropane tri(meth)acrylate, including their ethoxylated variants

Specific examples of suitable co-monomers which may be present in the acrylic resin include styrene, acrylonitrile, acrylamide, N-methylol acrylamide, methacrylamide vinyl esters such as vinyl acetate, vinyl ethers such as lower alkyl vinyl ethers, allyl monomers such as allyl acetate, olefins such as lower alkenes, vinyl halides and vinylidene halides such as vinyl chloride and vinylidene chloride and urethane acrylates, ethoxylated variants of these and other suitable substances that copolymerise by addition polymerisation in aqueous media.

The acrylic polymers are preferably prepared by emulsion polymerization in aqueous media by standard methods such as thermal activation or redox activation. The glass transition temperature—Tg of the desired polymer may be calculated using the copolymer equation and is achieved by suitable choice and levels of reactive monomers. The acrylic compositions are in this instance water based emulsions. The emulsions are optionally stabilized by addition of surfactants such as sodium dodecylbenzene sulphonate or alkyl/aryl ethoxylates.

Acrylic resins can also be prepared in non-aqueous media. When non aqueous media is used the monomers are dissolved in suitable non-aqueous solvents that are then polymerised to a desired end-point.

The organic solids content is typically from 10-60% but is preferably from 45-55% solid by weight.

The composition of the invention comprises nanoparticulate zinc oxide by which we mean zinc oxide of particle size up to 100 nm. Typically the zinc oxide component comprises at least 80% by weight of particles of size in the range of from 10 to 100 nm and more preferably at least 90% by weight in the range of from 10 to 50 nm.

It is a feature of the invention that free acid content of the acrylic composition needs to be less than 0.5 grams of potassium hydroxide (KOH) per kilogram of resin solids as measured by titration with 0.1 M KOH solution to phenolphthalein end point. Also a suitably low free (non-volatile) alkali content is preferred. The low free acid content is important to ensuring that the zinc oxide remains unreacted and an effective UV absorber. “Acid-free” is equivalent to negligible levels below 0.5 g KOH/Kg of resin solids.

The composition of the invention typically contains a zinc oxide loading 0.5%-50.0%, preferably 5%-40%, more preferably 10%-30% by weight based on total weight of solids in acrylic polymer composition.

Nano size water based zinc oxide dispersions are preferably prepared by milling with suitable surfactants or hydroxylated organic compounds to deagglomerate zinc oxide and provide a stable suspension for mixing with the acid-free acrylic emulsion. An example of a process for milling zinc oxide is described in U.S. Pat. No. 6,083,490.

When the zinc oxide is dispersed in acrylic monomer and added to the monomer pre-emulsion, an encapsulated form of zinc oxide is provided. This can then be polymerized as above to produce an aqueous emulsion acrylic polymer having encapsulated zinc oxide particles in situ.

The compositions of the invention are particularly suited to use in clear coatings. When these dispersions are formulated into clear coatings, they provide extended UV protection to both the films and substrates (UV absorption up to 385 nm), reducing the degradation or fading due to UV, whilst providing excellent clarity and good adhesion to substrates.

The use of HALS to trap free radicals in the film, in conjunction with the zinc oxide, may further enhance the durability of the film and is preferred. We have found that we can have levels of 1% to 50% of the 10-100 nm zinc oxide, preferably 10-50 nm zinc oxide, mixed in suspension and added at 1-10% to the solids in the acrylic emulsion or solution and coated to a dry film thickness of 10 micron to 200 micron onto textiles, leather, timber, masonry, renders or concrete yet still maintain a clear film which offers greatly improved UV protection.

The acrylic composition of the invention may be prepared by mixing the particulate zinc oxide with an acrylic component. More preferably the composition is prepared by mixing an aqueous dispersion of zinc oxide with the acrylic emulsion or mixtures of different emulsions under low shear conditions. By adjusting the range of levels of zinc oxide in acrylic emulsion we can produce dispersions of zinc oxide, which does not re-agglomerate and give good UV absorption. Optionally, rheology modifiers and coating aids can be added to the acrylic polymer (resin), provided that these are compatible with the coating and that they do not contain strong acids or alkalis that can adversely react with the metal oxide.

The invention includes in a preferred embodiment coating the zinc oxide particles with a suitable acrylic monomer prior to polymerization. Subsequent polymerization results in zinc oxide nanoparticles encapsulated in acrylic resin. The coated zinc oxide dispersed which is preferably in the form of an acrylic emulsion is protected from other acid sources or additions and can then be mixed with conventional acid containing commercial emulsions.

The compositions of the invention have a wide range of applications. Examples of applications include architectural coatings for wood including paints, varnishes, stains and clear sealers; architectural coatings for other substrates such as plaster, concrete, brick and metal; appliance finishes, automotive finishes, coil coatings, can coatings, marine coatings aircraft finishes, paper coatings; adhesives including pressure sensitive adhesives; caulks and sealants, water resistance agents, overprint varnishes and polishes for shoes, floors and furniture, including leather.

The invention will now be described with reference to the following examples. It is to be understood that the examples are provided by way of illustration of the invention and that they are in no way limiting to the scope of the invention.

### EXAMPLES

### Methods

Examples 11 to 13 as discussed with reference to the attached drawings.

In the drawings:

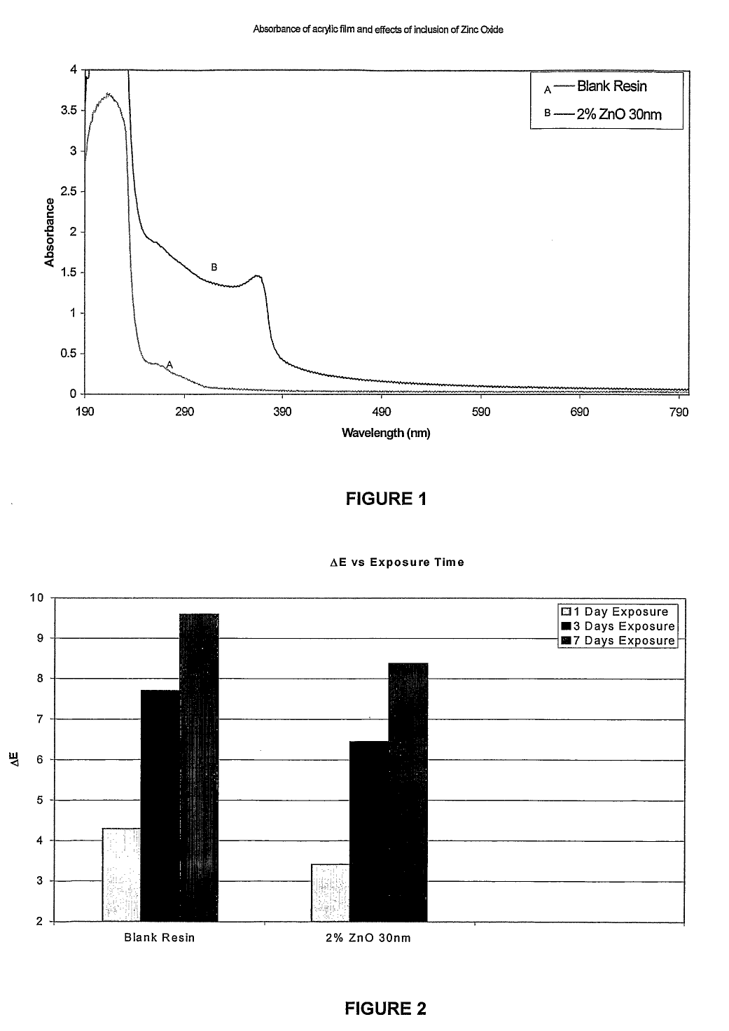

FIG. 1 is a graph showing the UV-Visible absorbance profiles (referred to in Example 11) of samples with dry film thickness of about 50 μm

FIG. 2 is a bar chart showing the colour difference of fabric samples after 1, 3 and 7 days of UV exposure (referred to in Example 12)

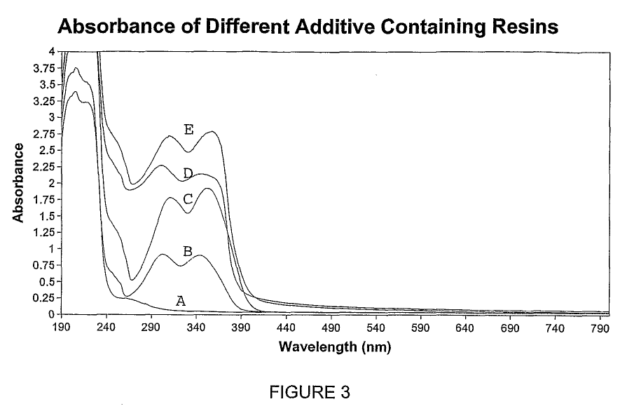

FIG. 3 show graphs of the UV —visible absorbance profiles of samples, resin—soft, mixed with water based dispersion of different stabilizers including ZnO with particle size—30 nm, Sanduvor 3225—a mixture of UV absorber and HALS, and Tinuvin 5151—a mixture of UV absorber and HALS

### Example 1

### Method of Polymerization Using REDOX Conditions

### Soft Acrylic Polymer Emulsion in Water—Acid Free

EQUIPMENT: Glass-lined reactor fitted with a variable speed stainless steel stirrer; hot water heating and cold water cooling; reflux condenser; peristaltic pumps; sample port and three delivery ports for supply of liquid streams; auto temperature measurement and controls; monomer pre-emulsion weigh tank and stirrer; catalyst feed tanks and stirrers; nitrogen gas supply; water-phase tank and stirrer.

PREPARATION OF PRE-EMULSION: Hot deionised water (111 g) was loaded into the water-phase tank. Rhodocal DS 10 (7.460 g) and Antarox C08805.124 (7.320 g) were added and dissolved. To the monomer pre-emulsion weigh tank were added Ebecryl 160 (0.490 g), methyl methacrylate (44.610 g), acrylonitrile (73.000 g), N-methylol acrylamide 48% solution (25.110 g), 2-ethylhexyl acrylate (179.000 g), butyl acrylate (179.000 g). The stirrer was set on high and the solution from the water-phase tank was added over 5 minutes to produce a stable monomer pre-emulsion which was then sparged with nitrogen gas for 10 minutes. The reactor was charged with deionised water (268.000 g), ferric ammonium sulphate (0.002 g), sodium bicarbonate (1.000 g). The stirrer was set to 40 rpm and the solution was sparged with nitrogen for 10 minutes whilst heating the solution (65° C.). Deionised water (34.000 g) was added to one catalyst feed tank followed by ammonium persulphate (1.100 g) and dissolved under stirring with nitrogen sparge. This is the catalyst solution. To the second catalyst feed tank, deionised water (34.000 g) was added followed by sodium formaldehyde sulphoxylate (1.100 g) and dissolved under stirring with nitrogen sparge. This is the reducer solution. Monomer pre-emulsion (62.700 g) was transferred to the reactor followed by catalyst solution (3.510 g total) and reducer solution (3.510 g total) added alternately in three equal aliquots. After initiation and evidence of exotherm (reactor temperature rise), the balance of the monomer pre-emulsion, catalyst solution and reducer solution are uniformly added over 240 minutes, maintaining 65° C. At the end of all additions, the resultant polymer is held at 65° C. for 1 hour then cooled to 50° C. where final adjustments are made for total solids (water) and pH (ammonia 0.400 g), then cooled to ambient and filtered (100 micron).

### Physical Characteristics:

| | |
|---|---|
| Appearance: | Milky white aqueous emulsion |
| Total solids content (105° C.; 1 hour): | 45 to 55% (typical 50%) |
| pH: | 7 to 9 (typical 7.5) |
| Viscosity (cPs): | <1000 (typical 200 to 600) |
| Tg (calc): | −30° C. |

The polymer emulsion is stable to shear and cast films are clear, soft and relatively tack-free.

### Example 2

### Method of Polymerization Using REDOX Conditions

### Medium Hardness Acrylic Polymer Emulsion in Water—Acid Free

As per example 1—except that the ratios of monomers used to produce the final Tg of the polymer was changed. Specifically methyl methacrylate (228.000 g); 2-ethylhexyl acrylate (87.300 g) and butyl acrylate (87.300 g) were used.

### Physical Characteristics:

| | |
|---|---|
| Appearance: | Milky white aqueous emulsion |
| Total solids content (105° C.; 1 hour): | 45 to 55% (typical 50%) |
| pH: | 7 to 9 (typical 7.5) |
| Viscosity (cPs): | <1000 (typical 200 to 600) |
| Tg (calc): | +19° C. |

The polymer emulsion is stable to shear and cast films are clear, tough flexible and tack-free.

### Example 3

### Method of Polymerization Using REDOX Conditions

### Hard Acrylic Polymer Emulsion in Water—Acid Free

As per examples 1 and 2, the levels of methyl methacrylate were adjusted at the expense of 2-ethylhexyl acrylate and butyl acrylate.

### Physical Characteristics:

| | |
|---|---|
| Appearance: | Milky white aqueous emulsion |
| Total solids content (105° C.; 1 hour): | 45 to 55% (typical 50%) |
| pH: | 7 to 9 (typical 7.5) |
| Viscosity (cPs): | <1000 (typical 200 to 600) |
| Tg (calc): | 45° C. |

The polymer emulsion is stable to shear and cast films are clear, tough and tack-free.

Aqueous acrylic polymers similar to the above examples were produced with lower and also higher Tg values also using other surfactants and other monomers and catalysts.

### Example 4

### Method of Polymerization Using Thermal Conditions

### Soft Acrylic Polymer Emulsion in Water—Acid Free

As per example 1 above, except that the reducer solution was not used. The reaction was conducted at higher temperature (80 to 95° C.) sufficient to ensure the activation of the catalyst.

Physical characteristics were very similar to example 1 except that the cast film had a slightly higher tack.

### Example 5

### Method of Polymerization Using Thermal Conditions

### Medium Hardness Acrylic Polymer Emulsion in Water—Acid Free

The monomer ratios were maintained as per example 2.

The method used was as per example 4.

Physical characteristics were similar to example 2.

### Example 6

### Method of Polymerization Using Thermal Conditions

### Hard Acrylic Polymer Emulsion in Water—Acid Free

The monomer ratios were maintained as per example 3.

The method used was as per example 4.

Physical characteristics were similar to example 3.

### Example 7

### Method of Polymerization Using REDOX Conditions

### Medium Hardness Acrylic Polymer Solution—Acid Free

As per example 2 except that non-aqueous solvent (s) such as Isopropyl alcohol or Methyl isobutyl ketone or Toluene or other suitable solvents and their blends were used. Non-ionic surfactants were optionally used if required. Anionic surfactants were omitted. Redox catalysts were selected from those suitable for the solvent of choice such as Ditertiarybutyl peroxide or perbenzoate, Ascorbic acid and glucose but not restricted to these examples.

The reactor was set up for reflux conditions and any water produced was removed.

### Physical Characteristics:

| | |
|---|---|
| Appearance: | Clear pale straw coloured liquid |
| Total solids content (105° C.; 1 hour): | 40 to 60% (typical 50%) |
| pH: | n/a |
| Viscosity (cPs): | <3000 (typical 1000) |
| Tg (calc): | +19° C. |

The polymer solution is stable to shear and cast films are clear, tough flexible and low tack.

Similar variants were also produced with various Tg ranging similarly to examples 1 and 3.

Similar acrylic solutions were also produced using a thermal method.

### Example 8

### Predispersion of Zinc Oxide in Aqueous Media for Post Dispersion in Acrylic Emulsion

Nano size zinc oxide was dispersed in water in a Hockmeyer mill 2 L (bead mill), beads used were 0.4-0.7 mm Jyoti.

Nano size zinc oxide (900 g), Orotan 731 DP (162 g), Teric N20 (12 gm), Teric N40 (12 g), propylene glycol (81 g), water (840 g), antifoam (23 g) were mixed together with a blade mixer to form even mixture, then loaded into Hockmeyer mill and milled for six hours.

### Example 9

### Predispersion of Zinc Oxide in Aqueous Media for Post Dispersion in Acrylic Emulsion

The experiment in example 7 was repeated on 1/33.33 scale in 40 L capacity Hockmeyer mill, beads used 0.4-0.7 mm Jyoti.

### Example 10

### ZnO Dispersion in Monomer to Enable Encapsulation of Zinc Oxide Particles in Polymer (Method as Per Example 1—Zinc Oxide Dispersion Added with 2EHA to Premonomer Phase)

Nano size zinc oxide (810 g) and monomer 2 ethylhexyl acrylate (430 g) were mixed together in a z-arm mixer for two hours, then Solsperse 21000 (12 g) was added gradually and mixed for one more hour.

### Example 11

### Zinc Oxide Stabilized Acrylic Composition Coated on Quartz Slide. UV Exposure Testing

UV absorbance profiles were measured on quartz slides, as shown in FIG. 1. Graph A represents the soft acrylic polymer emulsion dried to a film thickness of 50 micron. Graph B represents the same emulsion containing 2% zinc oxide at 30 nm particle size dried to a film thickness of 50 micron.

The absorbance profiles in FIG. 1 show a significant increase in absorbance for the resin containing the ZnO particles over the UV range.

### Example 12

### Zinc Oxide Stabilized Acrylic Composition Coated on Polyester Fabric. UV Exposure Testing

Polyester fabric—dyed orange was coated as follows. Draw downs of the two resin samples were performed at 50 micron dry film thickness. Blank resin graph refers to soft acrylic polymer emulsion. The 2% ZnO 30 nm graph refers to the same acrylic emulsion containing 2% zinc oxide at 30 nm particle size. Colour difference was measured after 1, 3 and 7 days of intense UV exposure. A substantial reduction in colour difference was observed in the samples containing the zinc oxide. Colour Difference of fabric samples at varying days of UV exposure is shown in FIG. 2.

### Example 13

### Zinc Oxide Stabilized Acrylic Composition with Different Additives Coated on Dyed Orange Polyester Fabric. Uv Exposure Testing

Polyester fabric—dyed orange was coated as follows. Draw downs of five resin samples were performed at 50 micron dry film thickness. The graphs A to E in FIG. 3 show absorbance results obtained with various additives. Graph A is blank resin and refers to soft acrylic polymer emulsion. Graph B is 3% HALS 1 and refers to the same emulsion containing the HALS 1 additive. Graph C is 3% HALS 2 and refers to the same emulsion containing the HALS 2 additive. Graph D refers to the same emulsion containing the 6% of zinc oxide 30 nm particle size together with 3% HALS 1 additive. Graph E refers to the same emulsion containing the 6% of zinc oxide 30 nm particle size together with 3% HALS 2 additive. A further enhancement of absorbance due to zinc oxide was the inclusion of HALS, whereas HALS alone did not provide sufficient absorbance.

### Example 14

### Zinc Oxide Stabilized Acrylic Composition Coated on Red Fabrics. UV Exposure Testing

Polyester fabric—screen printed with red on white was evaluated as follows:

Colour difference was measured by Hunterlab spectrophotometer, using ΔEcmc as the discriminator. ΔEcmc of 1.0 indicates the characterisation criteria for a barely acceptable commercial match. ΔEcmc greater than 1 is unacceptable.

ΔEcmc of 0.3 is generally accepted as the least difference a trained observer can barely detect. ΔEcmc of 0.4 is considered a critical match.

Fabric wet with water by padding with approximately 90% wet pickup, then dried for two minutes at 150° C. This fabric exposed to UV for 20 days, which simulates approximately eight months exterior exposure, showed a substantial fading and ΔEcmc of 4.8 compared to the unexposed sample.

Fabric treated with zinc oxide stabilized acrylic composition by padding at approximately 90% wet pickup then dried for two minutes at 150° C. This fabric exposed to UV for 20 days showed a slight fading and ΔEcmc of 0.4 compared to the unexposed treated sample.

The zinc oxide stabilised acrylic composition treatment of fabric thus showed substantial improvement in colourfastness (ΔEcmc of 0.4) compared to the untreated fabric (ΔEcmc of 4.8).

### Example 15

Zinc oxide stabilized acrylic composition coated on fabrics. UV exposure testing Polyester fabric yarns dyed navy blue was evaluated as follows:

An industry standard “blue wool scale” was used to characterise the light fastness of the fabrics. Each point on the blue wool scale indicates an approximate doubling of the longevity of the fabric in a harsh environment.

A blue fabric of light fastness of 3 to 4 was exposed to intense UV radiation until the highest rated colour on the blue wool scale just began to show a visual change to a trained observer.

This fabric was treated with zinc oxide stabilized acrylic composition by padding at approximately 90% wet pickup then dried for two minutes at 150° C. This fabric exposed to UV for 15 days showed an improvement of 1.5 points on a blue wool scale compared to the untreated fabric. This translates to an approximate three fold in longevity.

Acrylic compositions comprising nanoparticulate zinc oxide UV absorber The present invention relates to UV stabilized acrylic compositions and in particular to acrylic based systems containing a nano zinc oxide UV stabilizer and to a method of preparing UV stabilized acrylic coatings.

### BACKGROUND

Aqueous acrylic emulsions and solvent-based acrylics have been used for paints, timber vanishes, adhesives and textile coatings since the early 1950's. These acrylics are usually formulated with acrylic acid, methacrylic acid, itaconic acid or other acid groups to provide special features such as shear stability, adhesion, cross-linking, water resistance, required Tg, hardness, mar-resistance, mechanical stability and other desired properties.

Examples of typical acrylic emulsion are discussed in patents and product literature some of which will now be discussed. In what follows the discussion of documents, acts, materials, devices, articles and the like is included in this specification solely for the purpose of providing a context for the present invention. It is not suggested that any or all of these matters formed part of the prior art base or were common general knowledge in the field relevant to the present invention before the priority date of each claim of this application.

Uenoyama Yasuyuki in Japan (Asahi Chemical Industry Co., Ltd., Japan). Jpn. Kokai Tokkyo Koho JP 10120724 A2 12 May 1998 Heisei, JP 96-274874 17 Oct. 1996 describes the method of preparation of acrylic emulsion by emulsion polymerization of radically polymerizable monomers in aqueous media in the presence of UV absorbers and/or light stabilizers, such as Tinuvin 384, and modifying with silicones during or after the polymerization. The emulsions are suitable for adhesives, paper treatment and finishes for fabrics. An enamel coating was glossy and is said to be weather and water-resistant. Lorah et al in USA, patent US 2001-981350 17 Oct. 2001 describes a method for preparing an acrylic composition which is said to be suitable for use, when dry, as an improved elastomeric coating, caulk, sealant, fabric treatment or pressure sensitive adhesive. The composition is provided, including a predominantly acrylic aqueous emulsion polymer, the polymer having a glass transition temperature Tg from (−) 90 to 20 C, formed by the free radical polymerization of an ethylenically unsaturated nonionic acrylic monomer and 0-7.5%, (by wt. based on the total weight of the polymer), ethylenically unsaturated acid monomer in the presence of 0.01-1.0% tert-alkyl hydroperoxide, tert-alkyl peroxide, or tert-alkyl perester, wherein the tert-alkyl group includes 5 C atoms and, optionally, another oxidant.

Examples of industrial water based acrylic emulsions include:

Rohm & Haas: “Primal” range of water-based acrylic emulsions:

Primal AC 6501 M; Primal MV 23L0; Primal RHA 184; Primal RHA 194;

BASF: “Acronal” range of water-based acrylic emulsions:

Acronal 290 D; Acronal 250 D; Acronal 32 D; and

Valchem: “Valbond” range of water-based acrylic emulsions:

Valbond HBS 2; Valbond HBS 4; Valbond 7275; Valbond 82-48S.

There are some examples of lower acid water based acrylic resins, which have been made specifically for adhesives, such as

Rhodia: “Rhodatak” range of pressure-sensitive water based emulsion adhesives. These acrylic adhesive emulsions are not suitable for non tacky surface coatings.

Clear coatings made with water based acrylic emulsions or solvent based acrylics have major draw backs. Ultraviolet light produces relatively rapid deterioration in the film and in many cases also in the substrate coated by the film. In order to protect the coating film and the substrate from UV degradation, a range of organic UV absorbers and HALS (Hindered Amine Light Stabilizers) have been used. Organic UV absorbers mostly absorb in the range of 190-320 nm and do not give protection in the 320 to 400 nm UVA—band. HALS are free radical traps, may be used alone, but are often used in conjunction with organic UV absorbers in clear films. These products provide limited UV protection and will deactivate over time resulting in degradation of the film and substrate.

The use of physical UV—blockers such as zinc oxide of pigmentary grade (150-200 nm mean particle size) give protection in the region of 190-400 nm and in the visible band. They have been used effectively in UV absorbing acrylic composites. When zinc oxide of 150-200 nm particle size is mixed into an aqueous acrylic emulsion containing free acid groups, the outer part of the particle reacts with the acid to produce a zinc-polyacrylate coating, which protects the zinc oxide core residue from further reaction.

However the use of pigmentary grade zinc oxide of 150-200 nm and larger than 200 nm in aqueous acrylic emulsions (typical levels of 7%) is limited, because it produces milky or opaque films and leads to stability problems causing unwanted viscosity increases and altered rheology with poor can stability, gelling or “livering”.

### SUMMARY

In an attempt to improve the stability of clear films and acrylic compositions we conducted experiments using nano size zinc oxide. However we found that the use of nano size zinc oxide with commercial acrylic emulsions does not provide effective UV protection.

We have now found that by using acrylic compositions (or monomers for preparation thereof) with exceedingly low acidity (<0.5 g KOH/Kg of resin solids) we can use nano size zinc oxide dispersions (with particle size 10-100 nm, preferably 10-50 nm) to give a stable dispersion of zinc oxide for use in a range of coating applications.

Accordingly we provide in a first aspect of the invention an acrylic composition comprising an acrylic component selected from acrylic resins and precursors thereof and a nonoparticulate zinc oxide UV absorber wherein the acidity of the acrylic composition is less than 0.5 g KOH per kilogram of resin solids.

In a second aspect the invention provides a method of manufacture of a zinc oxide stabilized acrylic composition comprising forming an acrylic composition having an acidity of less than 0.5 g KOH per kilogram of resin solids and dispersing therein a nanoparticulate zinc oxide composition. The acrylic composition may be selected from acrylic resins and acrylic resin precursors such as the monomer compositions from which the acrylic resin is derived. In a third aspect the invention provides a zinc oxide composition comprising nanoparticulate zinc oxide comprising a surface coated with an acrylic monomer.

In a fourth aspect the invention provides a method of forming a zinc oxide stabilizing agent for an acrylic composition comprising:
contacting the zinc oxide nanoparticles with an acrylic monomer to form a coating of the monomer on the zinc nanoparticulates;
polymerizing a monomer composition comprising acrylic monomer in the presence of the acrylic monomer coated zinc oxide nanoparticles to provide zinc oxide encapsulated in acrylic resin.

In a fifth aspect the invention provides a coating composition comprising the above-described acrylic composition comprising the nanoparticulate zinc oxide and optionally other additives such as surfactants, defoamers, chain transfer agents, plasticisers initiators and stabilisers.

The coatings of the invention are particularly suitable for textiles. We have found that the composition provides significantly improved resistance to weathering and in many cases also enhances colour.

Accordingly in a sixth aspect the invention provides the use of the aforementioned composition as a textile coating and a textile coated therewith.

### DETAILED DESCRIPTION

The invention relates to acrylic resin compositions and in particular to acrylic film forming resins and coating compositions.

The composition of the invention comprises nanoparticulate zinc oxide and an acrylic composition selected from the group consisting of acrylic resins and precursors, such as monomer compositions, for preparation thereof. Without wishing to be bound by theory we believe the poor performance of nano zinc oxide in commercial emulsions results from the acid containing (above 0.5 g KOH/Kg of resin solids) acrylic emulsions dissolving the fine zinc oxide particles and/or from some of the zinc ions forming complexes with the polyacrylate. For example we found that when a commercially available emulsion such as Rohm & Haas (Primal AC 6501 M), which is typical of current commercial emulsions is mixed with 2% nano size zinc oxide (35 nm) and cast as a 50 μm film, UV absorption test showed that zinc oxide had dissolved and it provided no UV protection.

The term acrylic is used herein in a general sense to mean resins or monomer compositions for preparation thereof where a significant fraction of the monomeric units or monomers are selected from the group consisting of acrylic and methacrylic esters. It will be understood that co-monomers such as styrene, vinyl acetate, acrylonitrile, acrylamide, n-methylol acrylamide, vinyl acetate and others may be included. In what follows we describe a number of resin compositions but it will be appreciated that the corresponding monomer composition may also be used in admixture with the nanoparticulate zinc as a precursor to such a composition.

Copolymers and mixtures of monomers will preferably contain at least 10 mole percent of the total of acrylate plus methacrylate monomers based on the total mole of monomers. More preferably the proportion of acrylate plus methacrylate monomers is at least 20 mole percent and most preferably at least 40 mole percent.

The acrylic resin may be present in a range of forms. In one embodiment the acrylic resin is a high molecular weight thermoplastic acrylic such as acrylic resins of the type widely used as a coating for new automobiles and to a limited extent in repair and refinish of automobiles. The acrylic resin may be a thermo setting acrylic resin or non-aqueous dispersion (NAD) acrylic which is a thermosetting solution. Alternatively the acrylic may be in the form of acrylic latices which may commonly include styrene or vinyl acetate acrylic copolymer latices which are used in place of drying oils and alkyd systems.

In one embodiment the acrylic resin comprises hydroxy-functional thermosetting acrylics of the type widely used in baking enamels for automobile and appliance top coats, exterior can coatings and coil coatings.

Specific examples of acrylic resins are copolymers of acrylate and/or methacrylate esters of organic alcohols and other unsaturated monomers (that is having at least one double or triple bond) capable of reacting by additional polymerisation in aqueous media. The acrylate and methacrylate ester monomers may have alcohol portions selected from alkyl, hydroxyalkyl, alkoxyalkyl, alkylaminoalkyl and dialkylaminoalkyl. Such monomers are readily available. Specific commercially available examples include methyl (meth)acrylate, ethyl (meth)acrylate, n-butyl (meth)acrylate, isobutyl (meth)acrylate, isodecyl (meth)acrylate, lauryl (meth)acrylate, stearyl (meth)acrylate, 2-hydroxyethyl (meth)acrylate, 2-hydroxypropyl (meth)acrylate, 2-dimethylaminoethyl (meth)acrylate, 2-t-butylaminoethyl (meth)acrylate, glycidyl (meth)acrylate, ethylene glycol di(meth)acrylate, 1,3-butylene di(meth)acrylate and trimethylolpropane tri(meth)acrylate, including their ethoxylated variants

Specific examples of suitable co-monomers which may be present in the acrylic resin include styrene, acrylonitrile, acrylamide, N-methylol acrylamide, methacrylamide vinyl esters such as vinyl acetate, vinyl ethers such as lower alkyl vinyl ethers, allyl monomers such as allyl acetate, olefins such as lower alkenes, vinyl halides and vinylidene halides such as vinyl chloride and vinylidene chloride and urethane acrylates, ethoxylated variants of these and other suitable substances that copolymerise by addition polymerisation in aqueous media.

The acrylic polymers are preferably prepared by emulsion polymerization in aqueous media by standard methods such as thermal activation or redox activation. The glass transition temperature—Tg of the desired polymer may be calculated using the copolymer equation and is achieved by suitable choice and levels of reactive monomers. The acrylic compositions are in this instance water based emulsions. The emulsions are optionally stabilized by addition of surfactants such as sodium dodecylbenzene sulphonate or alkyl/aryl ethoxylates.

Acrylic resins can also be prepared in non-aqueous media. When non aqueous media is used the monomers are dissolved in suitable non-aqueous solvents that are then polymerised to a desired end-point.

The organic solids content is typically from 10-60% but is preferably from 45-55% solid by weight.

The composition of the invention comprises nanoparticulate zinc oxide by which we mean zinc oxide of particle size up to 100 nm. Typically the zinc oxide component comprises at least 80% by weight of particles of size in the range of from 10 to 100 nm and more preferably at least 90% by weight in the range of from 10 to 50 nm.

It is a feature of the invention that free acid content of the acrylic composition needs to be less than 0.5 grams of potassium hydroxide (KOH) per kilogram of resin solids as measured by titration with 0.1 M KOH solution to phenolphthalein end point. Also a suitably low free (non-volatile) alkali content is preferred. The low free acid content is important to ensuring that the zinc oxide remains unreacted and an effective UV absorber. “Acid-free” is equivalent to negligible levels below 0.5 g KOH/Kg of resin solids.

The composition of the invention typically contains a zinc oxide loading 0.5%-50.0%, preferably 5%-40%, more preferably 10%-30% by weight based on total weight of solids in acrylic polymer composition.

Nano size water based zinc oxide dispersions are preferably prepared by milling with suitable surfactants or hydroxylated organic compounds to deagglomerate zinc oxide and provide a stable suspension for mixing with the acid-free acrylic emulsion. An example of a process for milling zinc oxide is described in U.S. Pat. No. 6,083,490.

When the zinc oxide is dispersed in acrylic monomer and added to the monomer pre-emulsion, an encapsulated form of zinc oxide is provided. This can then be polymerized as above to produce an aqueous emulsion acrylic polymer having encapsulated zinc oxide particles in situ.

The compositions of the invention are particularly suited to use in clear coatings. When these dispersions are formulated into clear coatings, they provide extended UV protection to both the films and substrates (UV absorption up to 385 nm), reducing the degradation or fading due to UV, whilst providing excellent clarity and good adhesion to substrates.

The use of HALS to trap free radicals in the film, in conjunction with the zinc oxide, may further enhance the durability of the film and is preferred. We have found that we can have levels of 1% to 50% of the 10-100 nm zinc oxide, preferably 10-50 nm zinc oxide, mixed in suspension and added at 1-10% to the solids in the acrylic emulsion or solution and coated to a dry film thickness of 10 micron to 200 micron onto textiles, leather, timber, masonry, renders or concrete yet still maintain a clear film which offers greatly improved UV protection.

The acrylic composition of the invention may be prepared by mixing the particulate zinc oxide with an acrylic component. More preferably the composition is prepared by mixing an aqueous dispersion of zinc oxide with the acrylic emulsion or mixtures of different emulsions under low shear conditions. By adjusting the range of levels of zinc oxide in acrylic emulsion we can produce dispersions of zinc oxide, which does not re-agglomerate and give good UV absorption. Optionally, rheology modifiers and coating aids can be added to the acrylic polymer (resin), provided that these are compatible with the coating and that they do not contain strong acids or alkalis that can adversely react with the metal oxide.

The invention includes in a preferred embodiment coating the zinc oxide particles with a suitable acrylic monomer prior to polymerization. Subsequent polymerization results in zinc oxide nanoparticles encapsulated in acrylic resin. The coated zinc oxide dispersed which is preferably in the form of an acrylic emulsion is protected from other acid sources or additions and can then be mixed with conventional acid containing commercial emulsions.

The compositions of the invention have a wide range of applications. Examples of applications include architectural coatings for wood including paints, varnishes, stains and clear sealers; architectural coatings for other substrates such as plaster, concrete, brick and metal; appliance finishes, automotive finishes, coil coatings, can coatings, marine coatings aircraft finishes, paper coatings; adhesives including pressure sensitive adhesives; caulks and sealants, water resistance agents, overprint varnishes and polishes for shoes, floors and furniture, including leather.

The invention will now be described with reference to the following examples. It is to be understood that the examples are provided by way of illustration of the invention and that they are in no way limiting to the scope of the invention.

### Examples

### Methods

Examples 11 to 13 as discussed with reference to the attached drawings.

In the drawings:

FIG. 1 is a graph showing the UV-Visible absorbance profiles (referred to in Example 11) of samples with dry film thickness of about 50 μm

FIG. 2 is a bar chart showing the colour difference of fabric samples after 1, 3 and 7 days of UV exposure (referred to in Example 12)

FIG. 3 show graphs of the UV —visible absorbance profiles of samples, resin—soft, mixed with water based dispersion of different stabilizers including ZnO with particle size—30 nm, Sanduvor 3225—a mixture of UV absorber and HALS, and Tinuvin 5151—a mixture of UV absorber and HALS

### Example 1

### Method of Polymerization Using REDOX Conditions

### Soft Acrylic Polymer Emulsion in Water—Acid Free

EQUIPMENT: Glass-lined reactor fitted with a variable speed stainless steel stirrer; hot water heating and cold water cooling; reflux condenser; peristaltic pumps; sample port and three delivery ports for supply of liquid streams; auto temperature measurement and controls; monomer pre-emulsion weigh tank and stirrer; catalyst feed tanks and stirrers; nitrogen gas supply; water-phase tank and stirrer.

PREPARATION OF PRE-EMULSION: Hot deionised water (111 g) was loaded into the water-phase tank. Rhodocal DS 10 (7.460 g) and Antarox C08805.124 (7.320 g) were added and dissolved. To the monomer pre-emulsion weigh tank were added Ebecryl 160 (0.490 g), methyl methacrylate (44.610 g), acrylonitrile (73.000 g), N-methylol acrylamide 48% solution (25.110 g), 2-ethylhexyl acrylate (179.000 g), butyl acrylate (179.000 g). The stirrer was set on high and the solution from the water-phase tank was added over 5 minutes to produce a stable monomer pre-emulsion which was then sparged with nitrogen gas for 10 minutes. The reactor was charged with deionised water (268.000 g), ferric ammonium sulphate (0.002 g), sodium bicarbonate (1.000 g). The stirrer was set to 40 rpm and the solution was sparged with nitrogen for 10 minutes whilst heating the solution (65° C.). Deionised water (34.000 g) was added to one catalyst feed tank followed by ammonium persulphate (1.100 g) and dissolved under stirring with nitrogen sparge. This is the catalyst solution. To the second catalyst feed tank, deionised water (34.000 g) was added followed by sodium formaldehyde sulphoxylate (1.100 g) and dissolved under stirring with nitrogen sparge. This is the reducer solution. Monomer pre-emulsion (62.700 g) was transferred to the reactor followed by catalyst solution (3.510 g total) and reducer solution (3.510 g total) added alternately in three equal aliquots. After initiation and evidence of exotherm (reactor temperature rise), the balance of the monomer pre-emulsion, catalyst solution and reducer solution are uniformly added over 240 minutes, maintaining 65° C. At the end of all additions, the resultant polymer is held at 65° C. for 1 hour then cooled to 50° C. where final adjustments are made for total solids (water) and pH (ammonia 0.400 g), then cooled to ambient and filtered (100 micron).

### Physical Characteristics:

| | |
|---|---|
| Appearance: | Milky white aqueous emulsion |
| Total solids content (105° C.; 1 hour): | 45 to 55% (typical 50%) |
| pH: | 7 to 9 (typical 7.5) |
| Viscosity (cPs): | <1000 (typical 200 to 600) |
| Tg (calc): | −30° C. |

The polymer emulsion is stable to shear and cast films are clear, soft and relatively tack-free.

### Example 2

### Method of Polymerization Using REDOX Conditions

### Medium Hardness Acrylic Polymer Emulsion in Water—Acid Free

As per example 1—except that the ratios of monomers used to produce the final Tg of the polymer was changed. Specifically methyl methacrylate (228.000 g); 2-ethylhexyl acrylate (87.300 g) and butyl acrylate (87.300 g) were used.

### Physical Characteristics:

| | |
|---|---|
| Appearance: | Milky white aqueous emulsion |
| Total solids content (105° C.; 1 hour): | 45 to 55% (typical 50%) |
| pH: | 7 to 9 (typical 7.5) |
| Viscosity (cPs): | <1000 (typical 200 to 600) |
| Tg (calc): | +19° C. |

The polymer emulsion is stable to shear and cast films are clear, tough flexible and tack-free.

### Example 3

### Method of Polymerization Using REDOX Conditions

### Hard Acrylic Polymer Emulsion in Water—Acid Free

As per examples 1 and 2, the levels of methyl methacrylate were adjusted at the expense of 2-ethylhexyl acrylate and butyl acrylate.

### Physical Characteristics:

| | |
|---|---|
| Appearance: | Milky white aqueous emulsion |
| Total solids content (105° C.; 1 hour): | 45 to 55% (typical 50%) |
| pH: | 7 to 9 (typical 7.5) |
| Viscosity (cPs): | <1000 (typical 200 to 600) |
| Tg (calc): | 45° C. |

The polymer emulsion is stable to shear and cast films are clear, tough and tack-free.

Aqueous acrylic polymers similar to the above examples were produced with lower and also higher Tg values also using other surfactants and other monomers and catalysts.

### Example 4

### Method of Polymerization Using Thermal Conditions

### Soft Acrylic Polymer Emulsion in Water—Acid Free

As per example 1 above, except that the reducer solution was not used. The reaction was conducted at higher temperature (80 to 95° C.) sufficient to ensure the activation of the catalyst.

Physical characteristics were very similar to example 1 except that the cast film had a slightly higher tack.

### Example 5

### Method of Polymerization Using Thermal Conditions

### Medium Hardness Acrylic Polymer Emulsion in Water—Acid Free

The monomer ratios were maintained as per example 2.

The method used was as per example 4.

Physical characteristics were similar to example 2.

### Example 6

### Method of Polymerization Using Thermal Conditions

### Hard Acrylic Polymer Emulsion in Water—Acid Free

The monomer ratios were maintained as per example 3.

The method used was as per example 4.

Physical characteristics were similar to example 3.

### Example 7

### Method of Polymerization Using REDOX Conditions

### Medium Hardness Acrylic Polymer Solution—Acid Free

As per example 2 except that non-aqueous solvent (s) such as Isopropyl alcohol or Methyl isobutyl ketone or Toluene or other suitable solvents and their blends were used. Non-ionic surfactants were optionally used if required. Anionic surfactants were omitted. Redox catalysts were selected from those suitable for the solvent of choice such as Ditertiarybutyl peroxide or perbenzoate, Ascorbic acid and glucose but not restricted to these examples. The reactor was set up for reflux conditions and any water produced was removed.

### Physical Characteristics:

| | |
|---|---|
| Appearance: | Clear pale straw coloured liquid |
| Total solids content (105° C.; 1 hour): | 40 to 60% (typical 50%) |
| pH: | n/a |
| Viscosity (cPs): | <3000 (typical 1000) |
| Tg (calc): | +19° C. |

The polymer solution is stable to shear and cast films are clear, tough flexible and low tack.

Similar variants were also produced with various Tg ranging similarly to examples 1 and 3.

Similar acrylic solutions were also produced using a thermal method.

### Example 8

### Predispersion of Zinc Oxide in Aqueous Media for Post Dispersion in Acrylic Emulsion

Nano size zinc oxide was dispersed in water in a Hockmeyer mill 2 L (bead mill), beads used were 0.4-0.7 mm Jyoti.

Nano size zinc oxide (900 g), Orotan 731 DP (162 g), Teric N20 (12 gm), Teric N40 (12 g), propylene glycol (81 g), water (840 g), antifoam (23 g) were mixed together with a blade mixer to form even mixture, then loaded into Hockmeyer mill and milled for six hours.

### Example 9

### Predispersion of Zinc Oxide in Aqueous Media for Post Dispersion in Acrylic Emulsion

The experiment in example 7 was repeated on 1/33.33 scale in 40 L capacity Hockmeyer mill, beads used 0.4-0.7 mm Jyoti.

### Example 10

### ZnO Dispersion in Monomer to Enable Encapsulation of Zinc Oxide Particles in Polymer (Method as Per Example 1—Zinc Oxide Dispersion Added with 2EHA to Premonomer Phase)

Nano size zinc oxide (810 g) and monomer 2 ethylhexyl acrylate (430 g) were mixed together in a z-arm mixer for two hours, then Solsperse 21000 (12 g) was added gradually and mixed for one more hour.

### Example 11

### Zinc Oxide Stabilized Acrylic Composition Coated on Quartz Slide. UV Exposure Testing

UV absorbance profiles were measured on quartz slides, as shown in FIG. 1. Graph A represents the soft acrylic polymer emulsion dried to a film thickness of 50 micron. Graph B represents the same emulsion containing 2% zinc oxide at 30 nm particle size dried to a film thickness of 50 micron.

The absorbance profiles in FIG. 1 show a significant increase in absorbance for the resin containing the ZnO particles over the UV range.

### Example 12

### Zinc Oxide Stabilized Acrylic Composition Coated on Polyester Fabric. UV Exposure Testing

Polyester fabric—dyed orange was coated as follows. Draw downs of the two resin samples were performed at 50 micron dry film thickness. Blank resin graph refers to soft acrylic polymer emulsion. The 2% ZnO 30 nm graph refers to the same acrylic emulsion containing 2% zinc oxide at 30 nm particle size. Colour difference was measured after 1, 3 and 7 days of intense UV exposure. A substantial reduction in colour difference was observed in the samples containing the zinc oxide. Colour Difference of fabric samples at varying days of UV exposure is shown in FIG. 2.

### Example 13

### Zinc Oxide Stabilized Acrylic Composition with Different Additives Coated on Dyed Orange Polyester Fabric. UV Exposure Testing

Polyester fabric—dyed orange was coated as follows. Draw downs of five resin samples were performed at 50 micron dry film thickness. The graphs A to E in FIG. 3 show absorbance results obtained with various additives.

Graph A is blank resin and refers to soft acrylic polymer emulsion. Graph B is 3% HALS 1 and refers to the same emulsion containing the HALS 1 additive. Graph C is 3% HALS 2 and refers to the same emulsion containing the HALS 2 additive. Graph D refers to the same emulsion containing the 6% of zinc oxide 30 nm particle size together with 3% HALS 1 additive. Graph E refers to the same emulsion containing the 6% of zinc oxide 30 nm particle size together with 3% HALS 2 additive. A further enhancement of absorbance due to zinc oxide was the inclusion of HALS, whereas HALS alone did not provide sufficient absorbance.

### Example 14

### Zinc Oxide Stabilized Acrylic Composition Coated on Red Fabrics. UV Exposure Testing

Polyester fabric—screen printed with red on white was evaluated as follows:

Colour difference was measured by Hunterlab spectrophotometer, using ΔEcmc as the discriminator. ΔEcmc of 1.0 indicates the characterisation criteria for a barely acceptable commercial match. ΔEcmc greater than 1 is unacceptable.

ΔEcmc of 0.3 is generally accepted as the least difference a trained observer can barely detect. ΔEcmc of 0.4 is considered a critical match.

Fabric wet with water by padding with approximately 90% wet pickup, then dried for two minutes at 150° C. This fabric exposed to UV for 20 days, which simulates approximately eight months exterior exposure, showed a substantial fading and ΔEcmc of 4.8 compared to the unexposed sample.

Fabric treated with zinc oxide stabilized acrylic composition by padding at approximately 90% wet pickup then dried for two minutes at 150° C. This fabric exposed to UV for 20 days showed a slight fading and ΔEcmc of 0.4 compared to the unexposed treated sample.

The zinc oxide stabilised acrylic composition treatment of fabric thus showed substantial improvement in colourfastness (ΔEcmc of 0.4) compared to the untreated fabric (ΔEcmc of 4.8).

### Example 15

Zinc oxide stabilized acrylic composition coated on fabrics. UV exposure testing Polyester fabric yarns dyed navy blue was evaluated as follows:

An industry standard “blue wool scale” was used to characterise the light fastness of the fabrics. Each point on the blue wool scale indicates an approximate doubling of the longevity of the fabric in a harsh environment. A blue fabric of light fastness of 3 to 4 was exposed to intense UV radiation until the highest rated colour on the blue wool scale just began to show a visual change to a trained observer.

This fabric was treated with zinc oxide stabilized acrylic composition by padding at approximately 90% wet pickup then dried for two minutes at 150° C. This fabric exposed to UV for 15 days showed an improvement of 1.5 points on a blue wool scale compared to the untreated fabric. This translates to an approximate three fold in longevity.

1. An acrylic composition comprising an acrylic component selected from acrylic resins and precursors thereof and a nonoparticulate zinc oxide UV absorber wherein the acidity of the acrylic composition is less than 0.5 g KOH per kilogram of resin solids.

2. An acrylic composition according to claim 1 wherein the zinc oxide component comprises at least 80% by weight of particles of size in the range of from 10 to 100 nm.

3. An acrylic composition according to claim 2 wherein the zinc oxide component comprises at least 90% by weight in the range of from 10 to 50 nm.

4. A composition according to claim 1 wherein the zinc oxide is present in an amount of from loading 0.5%-50.0% by weight based on solids in acrylic resin.

5. An acrylic composition according to claim 1 where the acrylic component is selected from the group consisting of resins and monomer compositions for preparation thereof where a significant fraction of the monomeric units are selected from the group consisting of acrylic and methacrylic esters.

6. An acrylic composition according to claim 1 wherein the acrylic component comprises a high molecular weight thermoplastic acrylic resin.

7. An acrylic composition according to claim 1 wherein the acrylic component comprises a thermo setting acrylic resin or non-aqueous dispersion (NAD) acrylic which is a thermosetting solution.

8. An acrylic composition according to claim 1 in the form of an oil in water emulsion.

9. An acrylic composition according to claim 1 where the acrylic component comprises copolymers of acrylate and/or methacrylate esters of organic alcohols with other unsaturated monomers capable of reacting by additional polymerisation in aqueous media.

10. An acrylic composition according to claim 1 wherein the resin or precursor comprises acrylate and/or methacrylate ester monomers having alcohol portions selected from one or more of the groups of alkyl, hydroxyalkyl, alkoxyalkyl, alkylaminoalkyl and dialkylaminoalkyl.

11. An acrylic composition according to claim 1 wherein the acrylic component is an acrylic polymer resin in an aqueous emulsion.

12. An acrylic composition according to claim 8 wherein the organic solids content is in the range of 10-60%.

13. An acrylic composition according to claim 1 prepared by milling zinc oxide in the presence of dispersants selected from the group consisting of surfactants and hydroxylated organic compounds and mixing the milled zinc oxide dispersion with acrylic emulsion having an acidity of less than 0.5 g KOH per kilogram of resin solids.

14. A method of manufacture of a zinc oxide stabilized acrylic composition comprising forming an acrylic composition having an acidity of less than 0.5 g KOH per kilogram of resin solids and dispersing therein a nanoparticulate zinc oxide composition.

15. An acrylic composition according to claim 1 wherein the acrylic component is acryclic monomer of acidity less than 0.5 g KOH per kilogram resin and forms a coating on the nanoparticulate zinc oxide.

16. A method of forming a zinc oxide stabilizing agent for an acrylic composition comprising:
contacting the zinc oxide nanoparticles with an acrylic monomer to form a coating of the monomer on the zinc nanoparticulates;
polymerizing a monomer composition comprising acrylic monomer in the presence of the acrylic monomer coated zinc oxide nanoparticles to provide zinc oxide encapsulated in acrylic resin wherein the acidity of the acrylic resin is less than 0.5 g KOH per kilogram of resin.

17. A coating composition comprising and acrylic composition according to claim 1 one or more components selected from the group consisting of surfactants, defoamers, chain transfer agents, plasticisers initiators and stabilisers.

18. A coating composition according to claim 17 applied to textiles.
